(19) United States
(12) Patent Application Publication
(10) Pub. No.: US 2018/0254067 A1
(43) Pub. Date: Sep. 6, 2018

(54) METHODS AND SYSTEMS FOR EDITING AND SHARING VIDEO AND AUDIO CONTENT

(71) Applicant: NEXVIDEA INC., Spring, TX (US)

(72) Inventor: Lloyd John ELDER, Edmonton (CA)

(21) Appl. No.: 15/970,308

(22) Filed: May 3, 2018

Related U.S. Application Data
(63) Continuation of application No. PCT/US2016/061193, filed on Nov. 9, 2016.
(60) Provisional application No. 62/252,824, filed on Nov. 9, 2015.
(60) Provisional application No. 62/280,484, filed on Jan. 19, 2016.

(51) Int. Cl. G11B 27/031; H04N 21/854; H04N 7/15; G06F 3/0484; G06F 3/0488

(52) U.S. Cl. CPC G11B 27/031; H04N 21/854; G06F 3/0488; G06F 3/04847; H04N 7/152

(57) ABSTRACT

A real-time video and audio editing and sharing command system is provided. The system comprises a display, one or more processors communicatively coupled to the display, and a memory, communicatively coupled to the one or more processors, including instructions executable by the one or more processors to receive and display one or more video streams, simultaneously or selectively, according to real-time user input, and during display, receive and transmit real-time user input, including editing commands or sharing commands directed to the one or more video streams. The one or more video streams can be received from an external processing system, and the real-time user input can be transmitted to the same external processing system for editing or sharing according to real-time user input.

### CROSS-REFERENCE

This application is a continuation application of International Application No. PCT/US2016/061193, filed Nov. 9, 2016, which application claims the benefit of U.S. Provisional Application No. 62/252,824, filed Nov. 9, 2015, and U.S. Provisional Application No. 62/280,484, filed Jan. 19, 2016, which applications are entirely incorporated herein by reference.

### BACKGROUND

Remote communication via video has become an important tool in business, education, healthcare and entertainment, as well as in social and familial contexts. This type of communication can occur via an integration of a wide array of real-time, enterprise, and communication services (e.g., instant messaging, voice, including IP telephony, audio, web & video conferencing, fixed-mobile convergence, desktop sharing, data sharing including web connected electronic interactive whiteboards) and non-real-time communication services (e.g., unified messaging, including integrated voicemail, e-mail, SMS and fax). In practice, one-to-one remote communications are commonly carried out with each participant having a computing device (e.g., laptop, desktop, tablet, mobile device, PDA, etc.) that comprises a fixed camera and a microphone by which to transmit audio and video, and a screen and speaker by which to receive audio and video from the other side. Similarly, in one-to-many remote communications, such as presentations on streaming services (e.g., YouTube®, Facebook®, etc.), the content is often created, or recorded, using fixed sensors such as a camera and a microphone.

A common challenge arises when a communicator or presenter desires to communicate via multiple simultaneous audio or video streams to his or her audience, such as by adding a different perspective to the images or video already being transferred. In such cases, the presenter must not only obtain further sensors, such as cameras and microphones, audio inputs, or video inputs, to separately connect to the communication stream, but also find additional personnel to handle recording and editing of the additional audio or video stream such that the final output stream is cohesive to the audience. There is therefore a need for a convenient system that allows users to edit and share in real-time one or more simultaneous audio and video content streams.

### SUMMARY

Recognized herein is the need for a convenient live-editing system that allows users to edit and share in real-time one or more simultaneous audio and video content streams.

A real-time video and audio editing and sharing command system is provided. The system comprises a display, one or more processors communicatively coupled to the display, and a memory, communicatively coupled to the one or more processors, including instructions executable by the one or more processors to receive and display one or more video streams, simultaneously or selectively, according to real-time user input, and during display, receive and transmit real-time user input, including editing commands or sharing commands directed to the one or more video streams.

The system may further comprise a speaker, communicatively coupled to the one or more processors, wherein the memory includes instructions executable by the one or more processors to receive and play one or more audio streams, simultaneously or selectively, according to real-time user input and, during play, receive and transmit real-time user input, including editing commands and sharing commands directed to the one or more audio streams.

The one or more video streams and audio streams can be received from an external processing system, and the real-time user input can be transmitted to the same external processing system for editing or sharing according to real-time user input.

The one or more video streams can be displayed simultaneously or selectively as individual, adjacent, or overlapping streams according to real-time user input or pre-programmed instructions.

The memory may further comprise instructions to display available editing commands to a user. The memory may further comprise instructions to display available sharing commands to a user. The one or more available editing commands may be displayed on the display at the same time as the one or more video streams. The available editing commands can be displayed to a user at the user's request. The available sharing commands can be displayed to a user at the user's request.

The sharing commands can include selecting which of the one or more video streams will be shared to which of one or more displays, one or more online streaming services, or one or more memory storage. The sharing commands can include selecting whether to share a raw video input stream or an edited video stream.

A method for editing and sharing video and audio in real-time is provided. The method comprises receiving simultaneously one or more video or audio streams, displaying, simultaneously or selectively, the one or more video streams as individual, adjacent, or overlapping streams according to real-time user input or pre-programmed instructions, and during display, receiving and transmitting real-time user input, including editing commands or sharing commands directed to the one or more video or audio streams.

The method may further comprise playing, simultaneously or selectively, the one or more audio streams as individual or overlapping streams according to real-time user input or pre-programmed instructions.

The method may further comprise, during display of the one or more video streams, displaying available editing commands to a user. The method may further comprise, during display of the one or more video streams, displaying available sharing commands to a user. The sharing commands can include selecting which of the one or more video streams will be shared to which of one or more displays, one or more online streaming services, or one or more memory storage. The sharing commands can include selecting whether to share a raw video input stream or an edited video stream.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 shows a multi-view audio and video stream generating device with a mobile device docking base.

FIG. 2 shows a multi-view audio and video stream generating device with a mobile device docking base, a mobile device docked thereon.

FIG. 3 shows a sensor and light source adjustment page in a mobile touchscreen interface.

FIG. 4 shows a zoom editing function in a mobile touchscreen interface.

FIG. 5 shows three video arrangement options in a mobile touchscreen interface with two video streams arranged in a (a) side-by-side mode, (b) corner insert mode, and (c) proportional mode.

FIG. 6 shows an upload page in a touchscreen mobile interface allowing for (a) video selection and (b) streaming services selection.

FIG. 7 shows a computer control system that is programmed or otherwise configured to implement methods provided herein.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

A real-time video and audio editing and sharing command system is provided. The system may allow a user to view simultaneously one or more video streams on a display and provide real-time editing commands and/or sharing commands directed to the one or more video streams. The user's commands can be executed by an external processing system, which can be hosted in a separate device. The editing can be performed by the external processing system, advantageously, to enhance the efficiency of the real-time editing process and conserve system processing capacity. The user's commands can be executed by the in real-time, such that the user may view the edits being made in the display as he or she commands them. Similarly, the system may allow a user to listen simultaneously to one or more audio streams on a speaker and provide real-time editing commands and/or sharing commands directed to the one or more audio streams. The user's commands can be executed by the external processing system, in real-time, such that the user may hear the edits being made in the speaker as he or she commands them. The one or more video streams and one or more audio streams may be provided to the system by the same external processing system performing the editing.

In an aspect, a real-time video and audio editing and sharing command system is provided. The system may comprise a display, one or more processors communicatively coupled to the display, and a memory, communicatively coupled to the one or more processors, including instructions executable by the one or more processors to receive and display one or more video streams, simultaneously or selectively, according to real-time user input, and during display, receive and transmit real-time user input, including editing commands or sharing commands directed to the one or more video streams.

In an aspect, a method for editing and sharing video and audio in real-time is provided. The method comprises receiving simultaneously one or more video or audio streams, displaying, simultaneously or selectively, the one or more video streams as individual, adjacent, or overlapping streams according to real-time user input or pre-programmed instructions, and during display, receiving and transmitting real-time user input, including editing commands or sharing commands directed to the one or more video or audio streams.

A multi-view editing system may comprise one or more processors, a memory, communicatively coupled to the one or more processors, including instructions executable by the one or more processors to run an editing software application, and/or a display communicatively coupled to the one or more processors. For example, the system may be a mobile computing device (e.g., laptop, tablet, mobile device, PDA) running a mobile software application. Alternatively, the system may be a non-mobile computing device, such as a desktop computer, running a desktop software application. The computing device may be capable of requesting and receiving real-time user input. Real-time can include a response time of less than 1 second, tenths of a second, hundredths of a second, or a millisecond. All of the editing commands or software response processes, such as those described further below, are capable of happening in real-time. A user may provide input to the computing device through a user interface. In some embodiments, user input interfaces may comprise user input buttons, switches, knobs, levers, keys, trackballs, touchpads, or any other type of user interactive device. Alternatively or in addition, the user may provide input through a touch-enabled display (e.g., touchscreen, touchpad) comprising a graphical user interface (GUI). Any description herein of any specific type of user input interfaces, such as touchscreens, may apply to any other type of user input interface. The display may be integrated in the computing device (e.g., mobile device screen, tablet screen) or otherwise communicatively coupled to the one or more processors (e.g., desktop monitors) via wired or wireless connection. The system may further comprise a speaker. The speaker may be integrated in the computing device or otherwise communicatively coupled to the one or more processors (e.g., external speakers, headphones, earphones) via wired or wireless connection. To enable wireless connection to external devices, such as external displays, external speakers, or external processors, the system may further comprise a WiFi-card (e.g., 802.11 b/g/n/ac) and Bluetooth module coupled to the one or more processors. The system may further employ other wireless technology such as near field communication (“NFC”) technology. The wireless connection may be made through a wireless network on the internet, intranet, and/or extranet, or through a Bluetooth pairing.

The system, through instructions in an editing software application, may receive one or more video and audio streams from an internal or external source. In one example, the system may receive the video and audio streams from an internal source, such as prerecorded content from an integrated memory storage or live feed from an integrated sensor, such as a camera or a microphone. For example, a camera or microphone may be integrated into a computing device that is also running an editing software application. Alternatively or in addition, the system may receive the video and audio streams from an external source, such as an external processing system communicatively coupled to the system's one or more processors. The external processing system may comprise an external processor. It may be beneficial to receive the video and audio streams from an external source to save the processing capacity and memory of the system, which are oftentimes limited for mobile systems (e.g., mobile devices running a mobile application). In one embodiment, the external processor can be part of an external audio and video stream generating device.

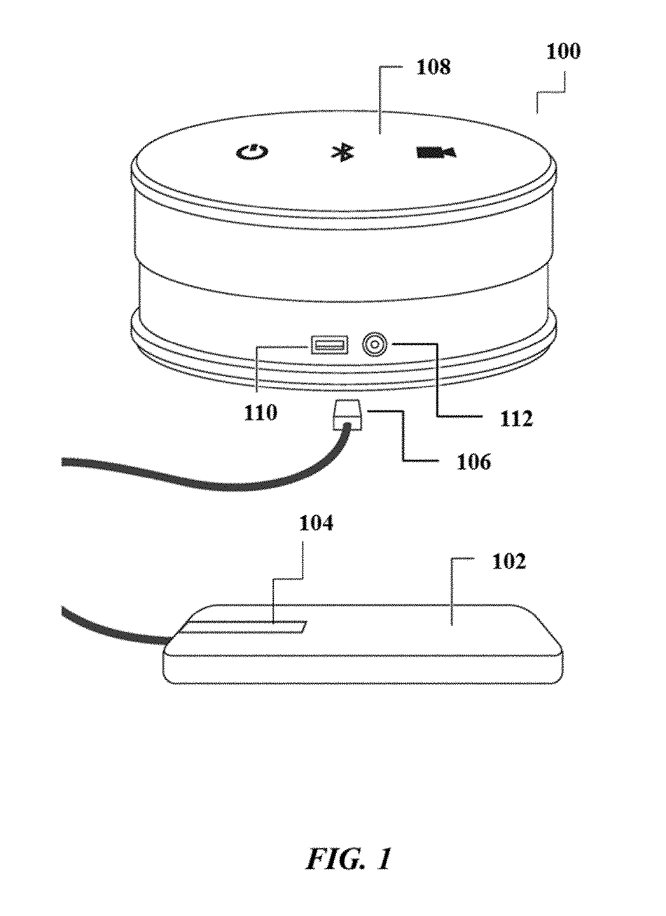

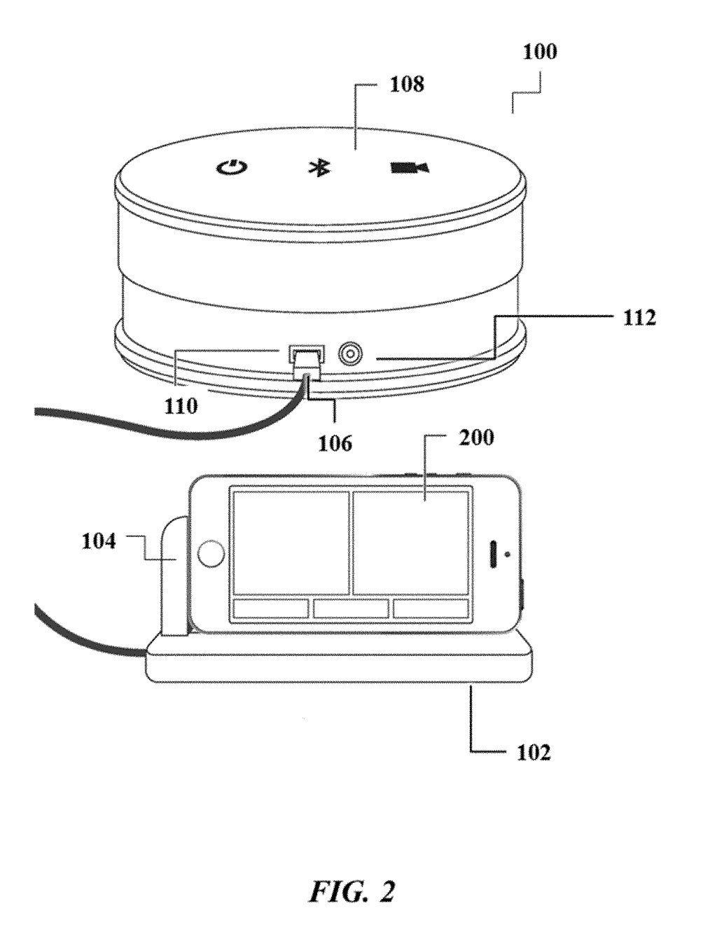

FIGS. 1-2 show an example of an external audio and video stream generating device coupled to a mobile device docking base. FIG. 1 shows an external audio and video stream generating device with a mobile device docking base, and FIG. 2 shows the device and docking base of FIG. 1, a mobile device docked thereon. In one example, a multi-view editing system, which can be a mobile device 200 running a mobile software application, can receive one or more video and audio streams from an external source, such as a multi-view audio and video stream generating device 100. An external processor embedded in the multi-view audio and video stream generating device may provide the video and audio streams. Any description herein of the external processor may apply to one or more external processors that may individually or collectively perform any of the functions described for the external processor. The system's one or more processors may be communicatively coupled to the external processor, for example, via a docking base 102. The docking base may comprise a foldable docking arm 104 and a connector 106 that can be coupled to a port 110 in the device 100. The port 110 can be coupled to the external processor. The mobile device can be docked onto the open docking arm, such as via a docking adapter, of the docking base and communicate with the external processor via the coupling of the connector and the port. Alternatively, the docking base can have other configurations that allow for a mobile device to be communicatively attached to the external processor in the external device. Alternatively, a mobile device can be directly coupled to the external processor without a docking base. Alternatively, a docking base can be integrated in the external device, such as via a docking adapter integrated in the external device. Alternatively, the mobile device can also be wirelessly connected to the external processor in the external device.

The external processor itself can receive one or more audio and video streams from a variety of sources. The audio and video streams may be live or pre-recorded inputs. In one embodiment, the external processor may receive the streams from one or more sensors communicatively coupled to the external processor. The sensors may include integrated sensors (e.g., integrated in the external device 100) and external sensors (e.g., aftermarket cameras or aftermarket microphones) and may communicate with the external processor via a cable connection or via a wireless connection. The external sensors may communicate with the external processor via a standard or custom connector or via a wireless connection. In one example, the external device 100 may have one or more integrated sensors that can be permanently or detachably attached to the device. The integrated sensors may have flexible positioning means (e.g., adjustable arms bridging the sensors and the external device). The integrated sensors may comprise one or more cameras and/or one or more microphones. A user may control each sensor individually without affecting another sensor. Both integrated sensors and external sensors may transmit video and/or audio signals to the external process in real-time as the signals are being recorded.

In one embodiment, the external processor may receive the streams from one or more external audio or video sources that are not cameras or microphones (e.g., game console, television output, radio output) communicatively coupled to the external processor. These external audio or video sources may communicate with the external processor via a standard or custom connector or via a wireless connection.

In one embodiment, the external processor may receive the streams from one or more memory storage communicatively coupled to the external processor, including plug-and-play hard-drives, flash memory (e.g., CompactFlash, SD card, mini SD card, micro SD card, USB drive), and cloud-based storage. The memory storage may communicate with the external processor via memory card slots or ports in the external processor or via a wireless connection such as to remote cloud-based storages.

In one embodiment, the external processor may receive the streams from other sources containing pre-recorded content such as pre-recorded videos, photographs, still images, overlays, or other assets. The pre-recorded content can be uploaded to the external processor from memory storage or over a wireless connection.

In one embodiment, the external processor may receive the streams from a combination of the above sources. The external processor may receive audio and video streams from the one or more sources simultaneously. The external processor may treat all audio and video streams received by the processor as editable assets. The external processor may transmit simultaneously each of the audio and video streams to the system's one or more processors for display and for the system to receive real-time user input, including editing commands directed to the audio and video streams. Alternatively, if the system processor has sufficient processing capability, the system processor may receive audio and video streams directly from the one or more sources. Alternatively, if the system process has sufficient processing capability, the system processor may receive some audio and video streams through the external processor and some audio and video streams directly from the one or more sources.

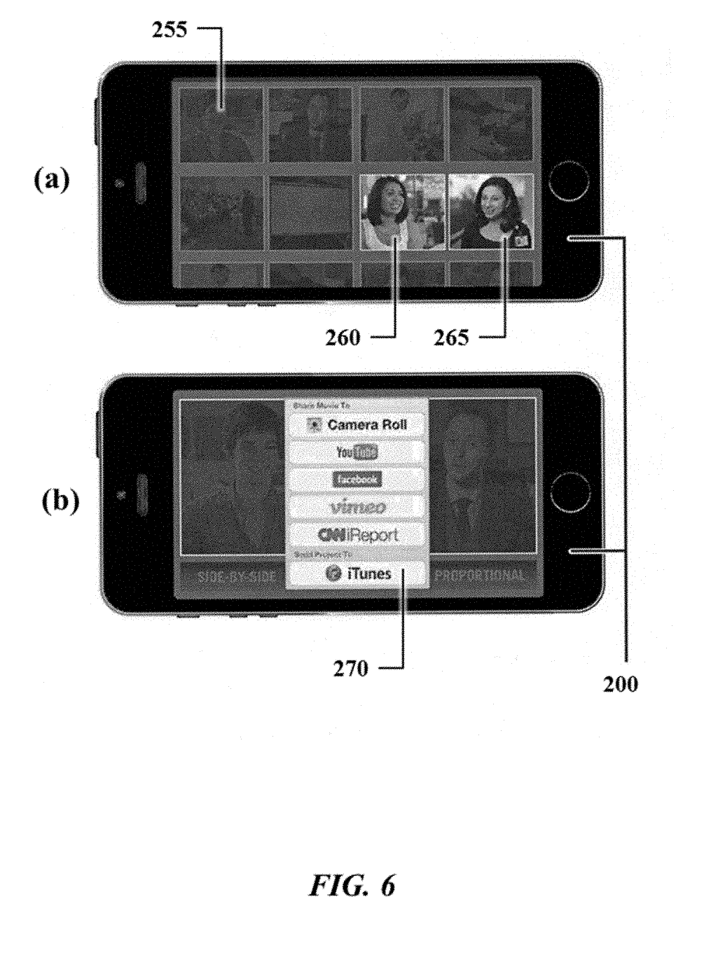

The editing software application may comprise instructions to display, simultaneously or selectively, one or more video streams as individual, adjacent, or overlapping streams according to real-time user input or pre-programmed instructions. Similarly, there may be instructions to play, simultaneously or selectively, one or more audio streams as individual or overlapping streams according to real-time user input or pre-programmed instructions. In one example, one video stream may be associated with one or more audio streams (e.g., in coordinated recordings). In one example, one audio stream may be associated with one or more video streams (e.g., in coordinated recordings). Audio and video streams associated together may be controlled separately or controlled together. An audio stream without an associated video stream may be displayed as a visual representation (e.g., tile, icon, image). Real-time user input, including editing commands, may change the arrangement of the one or more video streams or one or more audio streams. For example, once the system detects that it has received, or is receiving, one or more video and/or audio streams from an external processor, the system may, through the editing software application, present to a user a selection of video streams to display on the system display and a selection of audio streams to play on the system speaker. The selection of video streams may be presented as a grid of still images, each still image representative of one separate video stream (such as in FIG. 6(a)). The still image may be a preview of the video stream it represents, such as a still image taken from the video following pre-programmed instructions. Alternatively, the selection of video streams may be presented as a grid of videos, as it is streaming or in playback. Alternatively, the selection of video streams may be presented as a list of still images, a list of videos, or a list of video stream identifiers (e.g., “Camera 1,” “Camera 2”). An audio stream may be associated with a particular video stream (e.g., “Microphone 1” to “Camera 1”, “Microphone 2” to “Camera 2”), and may be selected automatically with the selection of the associated video stream. An audio stream may be associated with more than one video stream (e.g., “Microphone 1” to “Camera 1,” “Camera 2,” and “Camera 3”), and may be selected automatically with the selection of any of the associated video streams. Alternatively, a selection of audio streams may be presented as a list of audio stream identifiers (e.g., “Microphone 1,” “Microphone 2”). Alternatively, a selection of audio streams may be presented as a list or grid of visual representations (e.g., icons, tiles, images) of the audio streams. Video stream identifiers and audio stream identifiers may be unique nametags to each video stream and each audio stream, and can be given by the software application arbitrarily or following pre-programmed instructions (e.g., numbered in the order the stream is received, carried through from the source of the streams such as from the external processor). A user may select which of the one or more video streams to display on the system's display (e.g., mobile device screen) from the selection of video streams and which of the one or more audio streams to play on the system's speaker. In one example, the user may select one video stream to display individually on the system's display. In one example, the user may select two or more streams to display simultaneously on the system's display. In one example, the software application may comprise instructions to automatically display, without user selection, all video streams received by the system if the number of video streams received by the system is less than or equal to a certain number (e.g., 2, 3). If there are two or more video streams to display, their arrangement on the screen may be decided according to real-time user input or pre-programmed instructions. For example, the two or more video streams may be vertically adjacent, horizontally adjacent, or overlapping in some manner. In one example, the user may select which of the one or more audio streams to play with the one or more video streams selected. In one example, the software application may comprise instructions to play all, or some, audio streams associated with the selected one or more video streams.

The editing software application may further comprise instructions to request and receive real-time user input during display of the one or more video streams and/or during play of the one or more audio streams. For example, a user may view one or more video streams being simultaneously displayed on the system display screen, and at any point in time during display provide real-time editing commands as to one or more of the video streams. The system processor may transmit the real-time user input to an external processor, communicatively coupled to the system processor, which is transmitting the one or more video streams to the system. The same external processor can edit the one or more video streams according to the real-time user input, and transmit the one or more newly edited video streams to the system in real-time. Both the user input and the editing may happen in real-time such that a user may see the edits in the system display as he or she commands the edits. For example, if a user gives an editing command to crop the “Camera 1” video stream in the software application, the user may see the “Camera 1” video stream cropped on the system display in real-time.

The editing can be advantageously undertaken by an external processor in consideration of the efficiency of the overall real-time editing process and the respective processing capacities of the system processor and the external processor. That is, a user may use the editing software application as a user interface through which the user can give editing commands to an external processor. If the external processor has greater processing capabilities than the system processor, it may be advantageous for the external processor to perform the editing. Alternatively, if the system has sufficient processing capacity, the one or more system processors may also perform the editing. Alternatively, each of the system processor and the external processor can perform the editing, depending on the type of editing function commanded by the user. For example, an editing function that requires a relatively high processing power (e.g. generating 3-D video, adding video transition effects) can be performed by the external processor while an editing function that requires a relatively low processing power (e.g. applying a simple video filter) can be performed by the system processor. One or more processors, which can be a system processor or an external processor, can assess which processor is more appropriate to perform the user command and distribute the commands accordingly.

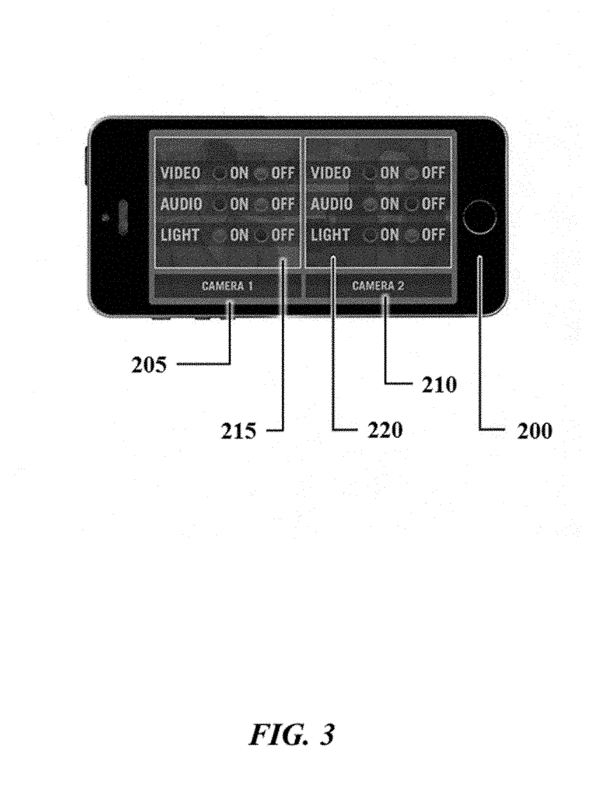

The editing software application may comprise a graphical user interface (GUI) through which a user can provide real-time user input. FIGS. 3-5 show examples of editing commands a user can provide on a GUI. In one example, if the system is receiving one or more video and/or audio streams as live feed from one or more sensors recording the video and audio content, a user may provide one or more editing commands to adjust one or more variables of each of the sensor and/or light source supporting the sensor. To execute the adjustments to the sensor, the system may transmit the real-time user input to an external processor communicatively coupled to the one or more sensors.

FIG. 3 shows an example of a sensor and light source adjustment page in a mobile touchscreen interface. A multi-view editing system may be a mobile device or any other type of computing device as described elsewhere herein. The system 200 may present to a user several variable adjustment options 215, 220 for each of the one or more video and/or audio streams 205, 210. For example, for a first video stream with the video stream identifier “Camera 1” 205, a user may be presented with variable adjustment options 215 such as “video on/off,” which can power on or off the camera sensor sending the “Camera 1” video stream feed, “audio on/off,” which can power on or off the microphone sensor associated with the “Camera 1” sensor, and “light on/off,” which can power on or off the light source supporting the “Camera 1” sensor. Similar and parallel options can be given for a second video stream with the video stream identifier “Camera 2” 210. Any number of multi-media streams may be provided, such as one, two, three, four, or more streams. Each of the multi-media streams may have the same adjustment options, or may have different adjustment options. Each of the streams may be adjusted independently of one another.

The software application may allow a user to adjust other variables of the one or more sensors and the one or more light source. For example, for a camera sensor, a user may additionally control zoom in/out and auto-focus on/off. For example, for a microphone sensor, a user may additionally control volume, pitch, audio level, audio balancing, or toggle between mono and stereo audio. For example, for a light source, a user may additionally control brightness, color change, strobing, pulsating, or adjusting a segment of lighting. The adjustment controls need not be binary such as having an “on/off” toggle, and can be, for example, a sliding bar with intermediary options (e.g., zoom at 0.5×, 1.0×, 1.5×, 2.0×). The adjustment options may appear in conjunction with the one or more video streams being displayed (i.e., on the same screen) such that a user can view the one or more video streams being edited on the system display. Alternatively, the adjustment options may appear as a transparent page layered over the one or more video streams being displayed (as in FIG. 3) such that a user can view the one or more video streams being edited on the system display in the background. Alternatively, the adjustment options may appear on an opaque page such that a user can return to viewing the one or more video streams as edited once the user closes the adjustment options page.

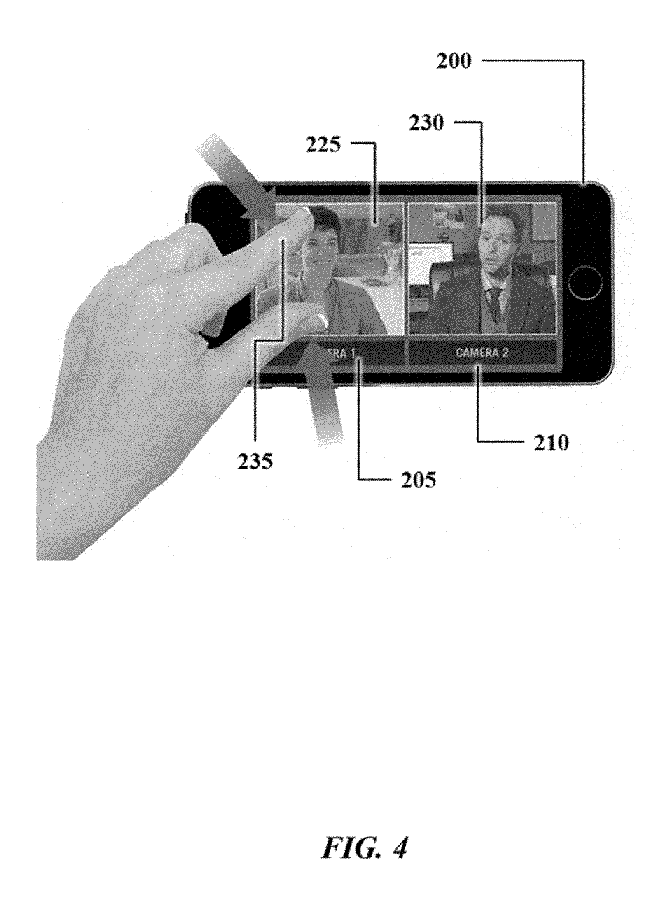

In one example, a user may provide editing commands using touch commands. FIG. 4 shows a zoom editing function in a mobile touchscreen interface. For example, a user may use his or her fingers 235 to ‘pinch’ or ‘stretch’ a first video stream 225 with a video stream identifier ‘Camera 1’ 205. The touch command may cause the first video stream to zoom out with a ‘pinch’ motion and zoom in with a ‘stretch’ motion. Giving a touch command on one video stream may leave the other video stream, such as the second video stream 230 having a video stream identifier ‘Camera 2’ 210, unaffected by the command. Any one video stream may be adjusted independently of one another. Alternatively, the software application may comprise instructions to allow for master commands where one editing command by the user can affect all video streams and/or audio streams.

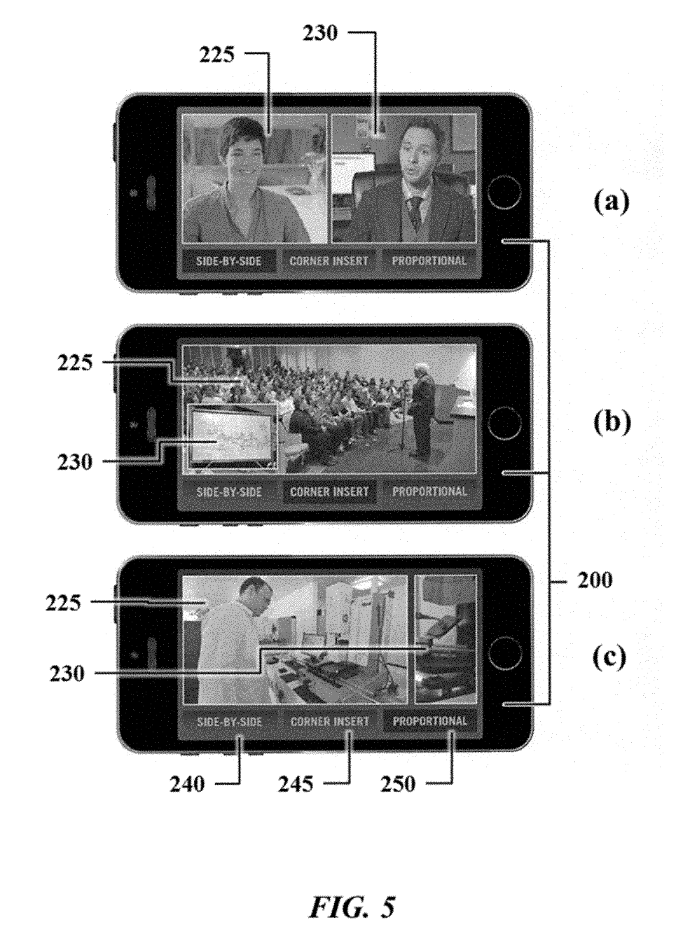

In one example, a user may provide real-time user input to change the arrangement of the one or more video streams shown on the system display. This may involve the splicing or stitching of one or more video streams by the external processor receiving the real-time user input. FIG. 5 shows three video arrangement options in a mobile touchscreen interface with two videos arranged in a (a) side-by-side mode, (b) corner insert mode, and (c) proportional mode. When there are multiple video streams, the system may provide a user with various options to arrange the multiple video streams on the display. For example, when there are two video streams, including a first video stream 225 and a second video stream 230, the system 200 may provide a user with different options 240, 245, 250 to arrange the two video streams on the display.

For example, in a side-by-side mode 240 (as in FIG. 5(a)) the first video stream and the second video stream may be arranged adjacent to the other in equal proportionate sizes without any overlap. The two video streams may be adjacent horizontally or vertically. To achieve equal proportion, the external processor may crop one or more edges of one or both of the video streams. The user may swap the positions of the two videos, such as via a toggle button or dragging a video image to the desired position (e.g., left, right).

In another example, a corner insert mode 245 is provided (as in FIG. 5(b)). The first video stream may be displayed in the full size of the system display and the second video stream may appear overlapping over a corner of the first video stream. The corner may be any corner, including bottom left, bottom right, top left, and top right. The user may select the corner to place the second video stream in. The user may select the size of the corner video stream. The user may swap the two video streams between which is the full size video stream and which is the corner video stream.

In another example, in a proportional mode 250 (as in FIG. 5(c)), the first video stream and the second video stream may be arranged adjacent to the other in different proportionate sizes without any overlap. The two video streams may be adjacent horizontally or vertically. The proportion ratio may vary as pre-programmed ratios (e.g., 1:2, 1:3, 1:4, etc.) or a user may input a desired custom ratio. The user may input a desired custom ratio as a number input, or via dragging a boundary divider to adjust the proportion. The user may swap the positions of the two videos such as via a toggle button or dragging a video image to the desired position (e.g., left, right). To achieve the desired proportion ratio, the external processor may crop one or more edges of one or both of the video streams.

The above three modes may apply to any number of video streams, including three or more video streams. For example, three video streams may be arranged horizontally adjacent to the other in equal proportionate sizes in side-by-side mode, and in different proportionate sizes in proportional mode. In one example, the software application may comprise instructions for a user to freely arrange the one or more video streams being displayed on the system display, such as freely adjusting the relative sizes of each video stream, freely adjusting the location of each video stream, and freely adjusting the portions overlapped of each video stream.

The editing software application may comprise instructions to allow a user to give various video and audio streams editing commands. In one example, a user may provide editing commands to stitch together different video streams and audio streams. For example, in a system receiving two video inputs and two audio inputs as a first audio stream, a second audio stream, a first video stream, and a second video stream, a user may provide a command to associate the first audio stream with the second video stream and the second audio stream with the first video stream. To that end, the user may selectively combine any video stream and any audio stream. In one example, a user may provide editing commands to add dynamic transitions or combination arrangements between two or more video streams in multiple locations, including rotation of a stream (e.g., 0 to 360 degrees), vertical tiling of streams, horizontal tiling of streams, copying a same stream in multiple locations, panning the stream, overlay, picture in picture, and any combination of the above. Alternatively, the software application can comprise instructions to stitch videos and audio streams according to a pre-programmed default setting in the event that there is no real-time user input, such as before a user inputs a first command to the system. In one example, a user can provide editing commands to use editable assets such as still images, overlays, text, sound clips, and music during the combination and editing of multiple video streams. In one example, a user can provide editing commands to apply filters that affect the appearance of one or more video streams. The software application may comprise a list of pre-programmed video filters from which a user may make a selection.

A user may provide real-time user input, or editing commands, to trigger one or more distinct editing sequences. The editing sequences can be preprogrammed in the editing software application such that a user need only select an option or a mode to trigger an external processor to start the editing sequence. The actual performance of the editing sequences can be advantageously undertaken by an external processor in consideration of the efficiency of the overall real-time editing process and the respective processing capacities of the system processor and the external processor. This can also keep the system's software package more compact by placing instructions to perform specific editing sequences in the memory of an external processor instead of the system memory.

In one example the user may select a ‘best white-balance performance’ mode. The external processor may automatically synchronize the color of a lighting source (e.g., adjustable color LEDs) supporting a camera sensor to achieve the best white-balance performance in the images or video being recorded by the camera sensor. The external processor may directly control sensors or light sources that are in communication with the external processor (e.g., integrated sensors). In one example, the user may select a 3-D perspective video mode. If the user selects the 3-D mode, the software application may provide guidance (e.g., visual guidelines in the system display) to help the user align and position two camera sensors in space to record two video streams that can be combined by an external processor into a single stream 3-D video format. In one example, the user may select a Chroma Key effect. For example, if a user selects the Chroma Key effect mode for a first video stream, an external processor can remove a single color (e.g., green) from the first video stream allowing the first video stream to have transparent sections. The user can then combine a second video stream, image, or pattern as the background of the first video stream that has been processed with the Chroma Key effect. The user may choose to combine, in layers, multiple video streams that have gone through Chroma Key and those that have not.

All of the editing commands and editing sequences, such as those described above and further below, are capable of happening in real-time. A user may provide editing commands directed to one or more video streams and/or audio streams as they are received and displayed to the user, and see the stream being edited as commanded. The one or more video streams and/or audio streams displayed by the system may be a live recording from a sensor, such as a camera or a microphone. Similarly, all of the sharing commands, such as those described further below, are capable of happening in real time.

The system can share the one or more raw or otherwise edited video streams to one or more displays, memory storage, online streaming services, or a combination of the above, according to real-time user input, including sharing commands. A user may provide a sharing command to transmit as video output streams a final edited video stream, or, alternatively, a specific video input stream. For example, if the system has two camera input streams and a choice of three video output displays, including a first camera input stream, a second camera input stream, a first display, a second display, and a third display, the user may provide commands to transmit the first camera input stream to the first display, the second camera input stream to the second display, and an edited video stream to the third display. The actual upload and transmission of the one or more video streams can be done by an external processor. The user may select which input stream and which edited stream will be transmitted to which display, memory storage, or online streaming services. A user may use this feature to, for example, stream multiple video perspectives of the same event to different streaming services or to view and prepare live video feeds for editing. In one example, the user may choose to additionally, or solely, transmit all edited streams to memory storage as backup.

If a combined video stream is being streamed to a streaming service platform, a user may edit in real-time the one or more video streams in the combined stream as it is being streamed. Streaming service platforms may include one-to-one live video communication platforms (e.g., Skype™, Facetime™) and one-to-many streaming distribution platforms (e.g., Youtube™, Vimeo™, Facebook Live™, Periscope™, YouNow™). FIG. 6 shows an upload page in a touchscreen mobile interface allowing for (a) video selection and (b) streaming services selection. As in FIG. 6(a), a user may select from a grid 255 or list of video streams which combination of video streams 260, 265 to share. A user may choose to select one video stream to share. The video streams may be a live feed or pre-recorded content recalled from a memory storage in the system. The system may allow sharing of one or more pre-edited streams saved to memory. The system may allow sharing of one or more streams as they are being edited in real-time.

As in FIG. 6(b), a user may select from a list 270 of known streaming service platforms (e.g., Skype™, Facetime™, Youtube™, Vimeo™, etc.) which platforms to share the combined video stream to. In one example, the software application may work in conjunction with known streaming service platforms through an application program interface (API), in which the known streaming platforms can identify, receive, and communicate the combined video stream from the system to the audience of the known streaming platform. The actual uploading of the streams can be done by an external processor once the external processor receives user input (e.g., video selection and streaming services selection). The uploaded stream can be a raw (i.e., un-edited) stream, a pre-edited stream that has been saved to memory, or a stream that is being edited in real-time. The external processor may upload one or more video streams to the Internet through wired connections (e.g., Ethernet cable) or wireless connections (e.g., WiFi). The one or more video streams can be transmitted to online streaming services using encoders over the Internet. The streaming can be done in an uncompressed format if the streaming service and bandwidth will allow such uncompressed format. Alternatively, the streaming can be done in a standard compressed format or one specific to the selected streaming service. The software application may have pre-programmed settings to configure the output video stream to satisfy the requirements of a specific streaming service. For example, if a user selects a first known streaming service, the external processor may configure the output video stream to satisfy the requirements of the first streaming service, and if the user selects a second known streaming service, which may or may not be different from the requirements of the first streaming service, the external processor may configure the output video stream to satisfy the requirements of the second streaming service. The pre-programmed settings may configure formats such as image aspect ratio, resolution, and orientation of the video stream. The system may connect to the known streaming platforms using a user's credentials and asking the user for permission to use such credentials on the user's behalf. Alternatively, the system may comprise specific software, besides the editing software application, to connect to specific streaming services. For example, the system may comprise a specific software application to connect to video communication services such as Skype™ or FaceTime™, in which the combined stream output is used in the place of a traditional video source (camera sensor, webcam, etc.) during video communications.

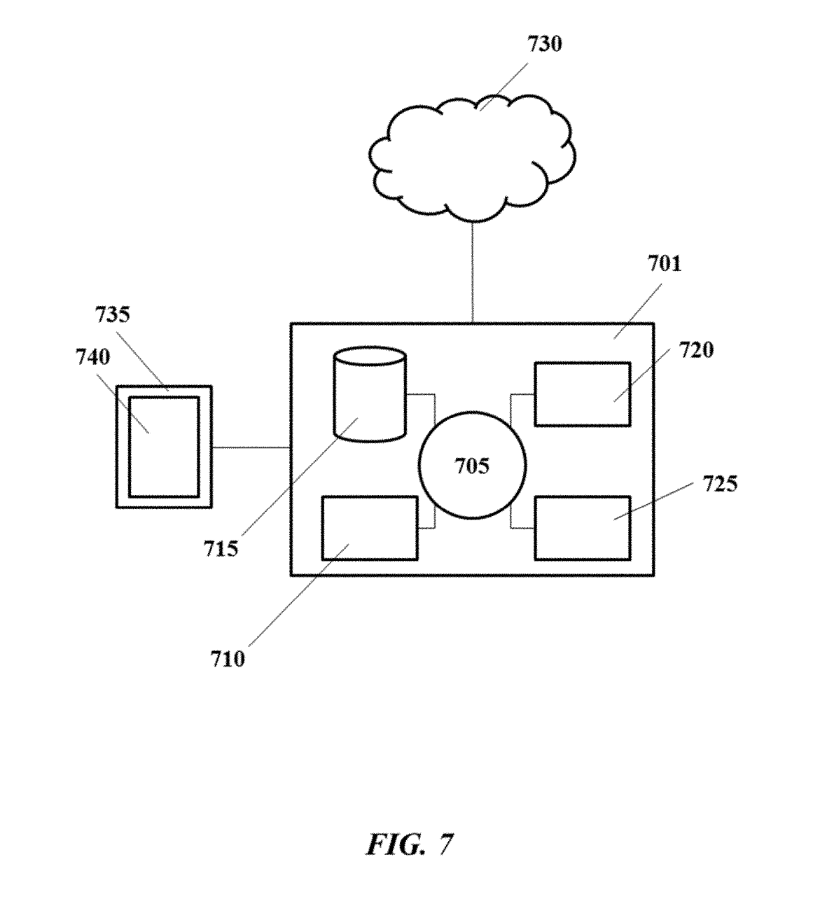

The present disclosure provides computer control systems that are programmed to implement methods of the disclosure. FIG. 7 shows a computer system 701 that is programmed or otherwise configured to run an editing software application and communicate with an external processor. The computer system 701 can regulate various aspects of the editing process provided in the present disclosure, such as, for example, distributing real-time user input commands between the system processor and the external processor and actively communicating with the external processor while displaying and/or streaming one or more video streams simultaneously received from the external processor. The computer system 701 can be an electronic device of a user or a computer system that is remotely located with respect to the electronic device. The electronic device can be a mobile electronic device.

The computer system 701 includes a central processing unit (CPU, also “processor” and “computer processor” herein) 705, which can be a single core or multi core processor, or a plurality of processors for parallel processing. The computer system 701 also includes memory or memory location 710 (e.g., random-access memory, read-only memory, flash memory), electronic storage unit 715 (e.g., hard disk), communication interface 720 (e.g., network adapter) for communicating with one or more other systems, and peripheral devices 725, such as cache, other memory, data storage and/or electronic display adapters. The memory 710, storage unit 715, interface 720 and peripheral devices 725 are in communication with the CPU 705 through a communication bus (solid lines), such as a motherboard. The storage unit 715 can be a data storage unit (or data repository) for storing data. The computer system 701 can be operatively coupled to a computer network (“network”) 730 with the aid of the communication interface 720. The network 730 can be the Internet, an internet and/or extranet, or an intranet and/or extranet that is in communication with the Internet. The network 730 in some cases is a telecommunication and/or data network. The network 730 can include one or more computer servers, which can enable distributed computing, such as cloud computing. The network 730, in some cases with the aid of the computer system 701, can implement a peer-to-peer network, which may enable devices coupled to the computer system 701 to behave as a client or a server.

The CPU 705 can execute a sequence of machine-readable instructions, which can be embodied in a program or software. The instructions may be stored in a memory location, such as the memory 710. The instructions can be directed to the CPU 705, which can subsequently program or otherwise configure the CPU 705 to implement methods of the present disclosure. Examples of operations performed by the CPU 705 can include fetch, decode, execute, and writeback.

The CPU 705 can be part of a circuit, such as an integrated circuit. One or more other components of the system 701 can be included in the circuit. In some cases, the circuit is an application specific integrated circuit (ASIC).

The storage unit 715 can store files, such as drivers, libraries and saved programs. The storage unit 715 can store user data, e.g., user preferences and user programs. The computer system 701 in some cases can include one or more additional data storage units that are external to the computer system 701, such as located on a remote server that is in communication with the computer system 701 through an intranet or the Internet.

The computer system 701 can communicate with one or more remote computer systems through the network 730. For instance, the computer system 701 can communicate with a remote computer system of a user (e.g., subscribers to streaming services). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 701 via the network 730.

Methods as described herein can be implemented by way of machine (e.g., computer processor) executable code stored on an electronic storage location of the computer system 701, such as, for example, on the memory 710 or electronic storage unit 715. The machine executable or machine readable code can be provided in the form of software. During use, the code can be executed by the processor 705. In some cases, the code can be retrieved from the storage unit 715 and stored on the memory 710 for ready access by the processor 705. In some situations, the electronic storage unit 715 can be precluded, and machine-executable instructions are stored on memory 710.

The code can be pre-compiled and configured for use with a machine having a processor adapted to execute the code, or can be compiled during runtime. The code can be supplied in a programming language that can be selected to enable the code to execute in a pre-compiled or as-compiled fashion.

Aspects of the systems and methods provided herein, such as the computer system 701, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 701 can include or be in communication with an electronic display 735 that comprises a user interface (UI) 740 for providing, for example, user editing controls. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 705. The algorithm can, for example, interpret touch commands in a touch-enabled system, resolve conflicting user input, and run pre-programmed instructions of the editing software application.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A real-time video and audio editing and sharing command system, comprising:
(a) A display;
(b) One or more processors, communicatively coupled to the display; and
(c) A memory, communicatively coupled to the one or more processors, including instructions executable by the one or more processors to receive and display one or more video streams, simultaneously or selectively, according to real-time user input and, during display, receive and transmit real-time user input, including editing commands or sharing commands directed to the one or more video streams.

2. The system of claim 1, further comprising a speaker, communicatively coupled to the one or more processors, wherein the memory includes instructions executable by the one or more processors to receive and play one or more audio streams, simultaneously or selectively, according to real-time user input and, during play, receive and transmit real-time user input, including editing commands and sharing commands directed to the one or more audio streams.

3. The system of claim 2, wherein the one or more video streams and one or more audio streams are received from an external processing system and the real-time user input is transmitted to the external processing system for editing or sharing according to real-time user input.

4. The system of claim 3, wherein the one or more video streams are displayed simultaneously or selectively as individual, adjacent, or overlapping streams according to real-time user input or pre-programmed instructions.

5. The system of claim 3, wherein the memory comprises instructions to display available editing commands to a user.

6. The system of claim 3, wherein the memory comprises instructions to display available sharing commands to a user.

7. The system of claim 5, wherein one or more available editing commands are displayed on the display at the same time as the one or more video streams.

8. The system of claim 5, wherein the available editing commands are displayed to a user at the user's request.

9. The system of claim 6, wherein the available sharing commands are displayed to a user at the user's request.

10. The system of claim 3, wherein the sharing commands include selecting which of the one or more video streams will be shared to which of one or more displays, one or more online streaming services, or one or more memory storage.

11. The system of claim 3, wherein the sharing commands include selecting whether to share a raw video input stream or an edited video stream.

12. A method for editing and sharing video and audio in real-time, comprising:
(a) Receiving simultaneously one or more video or audio streams;
(b) Displaying, simultaneously or selectively, the one or more video streams as individual, adjacent, or overlapping streams according to real-time user input or pre-programmed instructions; and
(c) During display, receiving and transmitting real-time user input, including editing commands or sharing commands directed to the one or more video or audio streams.

13. The method of claim 12, further comprising playing, simultaneously or selectively, the one or more audio streams as individual or overlapping streams according to real-time user input or pre-programmed instructions.

14. The method of claim 13, wherein the one or more video streams and one or more audio streams are received from an external processing system and the real-time user input is transmitted to the external processing system for editing or sharing according to real-time user input.

15. The method of claim 14, further comprising, during display of the one or more video streams, displaying available editing commands to a user.

16. The method of claim 14, further comprising, during display of the one or more video streams, displaying available sharing commands to a user.

17. The method of claim 14, wherein the sharing commands include selecting which of the one or more video streams will be shared to which of one or more displays, one or more online streaming services, or one or more memory storage.

18. The method of claim 17, wherein the sharing commands include selecting whether to share a raw video input stream or an edited video stream.
